(19) United States
(12) Patent Application Publication
(10) Pub. No.: US 2018/0329427 A1
(43) Pub. Date: Nov. 15, 2018

(54) METHOD AND DEVICE FOR OPERATING AN AUTOMATED VEHICLE

(71) Applicant: Robert Bosch GmbH, Stuttgart (DE)

(72) Inventor: Oliver Pink, Ditzingen (DE)

(21) Appl. No.: 15/970,214

(22) Filed: May 3, 2018

(30) Foreign Application Priority Data
May 15, 2017 (DE) 102017208163.5

(51) Int. Cl. G05D 1/02; G05D 1/00

(52) U.S. Cl. CPC G05D 1/0285; G05D 1/0246; G05D 2201/0213; G05D 1/0257; G05D 1/0022; G05D 1/0255

(57) ABSTRACT

In a method and device for operating an automated vehicle, steps are performed, which include receiving surroundings data values, which represent surroundings of the automated vehicle, determining an instantaneous driving situation in which the automated vehicle is situated as a function of the surroundings of the automated vehicle, and operating the automated vehicle as a function of the instantaneous driving situation.

### CROSS-REFERENCE TO RELATED APPLICATIONS

The present application claims priority under 35 U.S.C. § 119 to DE 10 2017 208 163.5, filed in the Federal Republic of Germany on May 15, 2017, the content of which is hereby incorporated by reference herein in its entirety.

### FIELD OF THE INVENTION

The present invention relates to a method and to a device for operating an automated vehicle, including a step of receiving surroundings data values, a step of determining an instantaneous driving situation in which the automated vehicle is situated, and a step of operating the automated vehicle, as a function of the instantaneous driving situation.

### SUMMARY

According to an example embodiment of the present invention, a method for operating an automated vehicle includes a step of receiving surroundings data values, which represent surroundings of the automated vehicle, a step of determining an instantaneous driving situation in which the automated vehicle is situated, as a function of the surroundings of the automated vehicle, and a step of operating the automated vehicle, as a function of the instantaneous driving situation.

An automated vehicle shall be understood to mean a semi, highly, or fully automated vehicle, for example.

This yields the advantage that the operation is adapted to the surroundings of the automated vehicle and the driving situation associated therewith, whereby the safety for the automated vehicle and/or for one or multiple occupants of the automated vehicle is increased.

Preferably, the determination of the instantaneous driving situation takes place in such a way that the instantaneous driving situation includes a localization of the automated vehicle and/or an operating state of the automated vehicle and/or a traffic situation in the surroundings of the automated vehicle.

A traffic situation is, for example, the presence and/or the behavior of additional road users (vehicles, pedestrians, etc.).

This is particularly advantageous since the driving situation is thus determined preferably completely, and the operation thus takes place very safely—for the automated vehicle and for the additional road users—as a function of the determined driving situation.

In a particularly preferred example embodiment, the determination of the instantaneous driving situation takes place outside the automated vehicle. This shall be understood to mean that the determination of the instantaneous driving situation takes place, for example, in a cloud and/or on an external server, as viewed relative to the automated vehicle.

This is particularly advantageous since, for example, the computing power of the automated vehicle required for this purpose is decreased and/or the computing power can be utilized for other functions and/or systems. Furthermore, it is advantageous since, for example, a larger and/or faster and/or more efficient computing power is available in a cloud and/or on an external server than is possible in the automated vehicle.

Preferably, the operation of the automated vehicle takes place in that the instantaneous driving situation is transmitted to the automated vehicle and/or a signal for controlling the automated vehicle as a function of the instantaneous driving situation is transmitted to the automated vehicle. This is particularly advantageous since the automated vehicle is thus operated safely based on the determined driving situation, as a function of the surroundings of the automated vehicle.

Preferably, the surroundings data values are detected with the aid of a surroundings sensor system of the automated vehicle and/or compressed with the aid of a data compression unit of the automated vehicle and/or transmitted with the aid of a transceiver unit of the automated vehicle.

A surroundings sensor system shall be understood to mean at least one video and/or radar and/or LIDAR and/or ultrasonic sensor and/or at least one further sensor which is/are designed to detect the surroundings of the automated vehicle.

In an example embodiment, the surroundings sensor system, in addition to at least one of the above-mentioned sensors, includes an evaluation unit designed to evaluate the detected surroundings data values, for example with the aid of a processor and/or working memory and/or a hard drive and/or suitable software, and, for example, to determine objects and/or surroundings features which are encompassed by the surroundings of the automated vehicle. This yields the advantage that the surroundings of the automated vehicle, which are used for determining the driving situation, are detected in real time. This allows the driving situation to be determined in a manner which is reliable and appropriate for the situation.

A compression of the surroundings data values with the aid of a data compression unit shall be understood to mean, for example, that the surroundings data values are compressed in that a change in the data format which requires less memory space is carried out with the aid of a processing unit. In a further example embodiment, in addition or as an alternative it shall be understood to mean that, for example, only a portion of the detected surroundings data values is selected, whereby the amount of data decreases. This yields the advantage that the surroundings data values can be transmitted more quickly and/or more energy-efficiently.

A transmission of the surroundings data values with the aid of a transceiver unit shall be understood to mean, for example, that the surroundings data values can be transmitted to a cloud and/or an external server, for example, with the aid of a radio link, proceeding from a corresponding transmission device, which is encompassed by the automated vehicle. In an example embodiment, a mobile transceiver unit, in particular a smart phone, for example, is used for this purpose, which is situated inside the automated vehicle and receives, and subsequently further transmits, the surroundings data values, proceeding from the surroundings sensor system, with the aid of a radio link, for example Bluetooth.

In an example embodiment, for example, a transceiver unit formed in the vehicle is used for this purpose, which transmits the surroundings data values, proceeding from the surroundings sensor system, with the aid of a mobile data link, for example GSM and/or UMTS and/or LTE. This yields the advantage that the surroundings data values can be transmitted quickly and to any arbitrary server and/or to a cloud.

The localization of the automated vehicle particularly preferably takes place in that the surroundings of the automated vehicle are assigned to a surroundings class. A surroundings class shall be understood to mean one of the following classes, for example: freeway, rural road, farm road, city, countryside, intersection, parking lot, parking garage, underground parking garage, garage, tunnel, bridge, forest, curve, multi-lane or single-lane roadway, roadway with or without or having little or a lot of roadway damage, etc. This yields the advantage that the driving situation can be determined quickly corresponding to the surroundings class, whereby, for example, the safety during operation of the automated vehicle is enhanced.

The determination of the operating state of the automated vehicle particularly preferably takes place in that the operating state is assigned to a motion class. A motion class shall be understood to mean one of the following classes, for example: standing, driving, accelerating, braking, fast and/or slow driving (for example as a function of a predefined speed value, which is determined as a function of the surroundings and/or as a function of the vehicle type of the automated vehicle and/or as a function of local laws), etc. This yields the advantage that the driving situation can be determined quickly corresponding to the motion class, whereby, for example, the safety during operation of the automated vehicle is enhanced.

Preferably, the determination of the instantaneous driving situation takes place in that the instantaneous driving situation corresponds to a combination of the surroundings class and the motion class. This yields the advantage that the driving situation can be determined quickly based on the combination, whereby, for example, the safety during operation of the automated vehicle is enhanced.

A device, according to an example embodiment of the present invention, for operating an automated vehicle includes first means for receiving surroundings data values, which represent surroundings of the automated vehicle, second means for determining an instantaneous driving situation in which the automated vehicle is situated, as a function of the surroundings of the automated vehicle, and third means for operating the automated vehicle, as a function of the instantaneous driving situation. The first means and/or the second means and/or the third means are designed to carry out a method described herein.

Exemplary embodiments of the present invention are shown in the drawings and are described in greater detail in the following description.

### BRIEF DESCRIPTION OF THE DRAWINGS

FIG. 1 shows a device according to an example embodiment of the present invention.

FIG. 2 illustrates a representation of a method according to an example embodiment of the present invention.

FIGS. 3a and 3b are flowcharts that illustrate methods according to example embodiments of the present invention.

### DETAILED DESCRIPTION

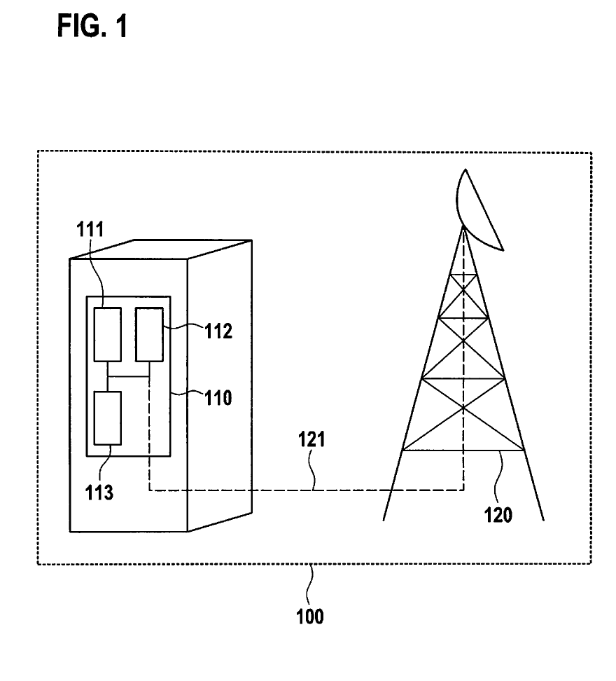

FIG. 1 shows a processing unit 100 that includes a device 110 for operating 330 an automated vehicle 200 according to an example embodiment. The processing unit 100 can be, for example, a server or a cloud, i.e., a combination of at least two electrical data processing systems that exchange data via the Internet, for example, or can correspond to device 110.

First device 110 encompasses first means 111 for receiving 320 surroundings data values, which represent surroundings 220 of automated vehicle 200, second means 112 for determining 320 an instantaneous driving situation in which automated vehicle 200 is situated, as a function of surroundings 220 of automated vehicle 200, and third means 113 for operating 330 automated vehicle 200, as a function of the instantaneous driving situation.

First means 111 and/or second means 112 and/or third means 113 can—as a function of the particular specific embodiment of processing unit 100—have differing designs. If processing unit 100 is designed as a server, first means 111 and/or second means 112 and/or third means 113 are localized in the same location, based on the location of first device 110.

If processing unit 100 is designed as a cloud, first means 111 and/or second means 112 and/or third means 113 can be localized in differing locations, for example in differing cities and/or in differing countries, a link—such as the Internet—being formed to exchange (electronic) data between first means 111 and/or second means 112 and/or third means 113.

First means 111 are designed to receive surroundings data values which represent surroundings 220 of automated vehicle 200. First means 111 include a transceiver unit, with the aid of which data are requested and/or received. In one further example embodiment, first means 111 are designed in such a way that these—proceeding from first device 110—are connected to an externally situated transceiver unit 122 with the aid of a cable link and/or wireless link 121. Furthermore, first means 111 include electronic data processing elements, for example a processor, a working memory and a hard drive, which are designed to store and/or to process the surroundings data values, for example to carry out a change and/or an adaptation of the data format, and to subsequently forward these to second means 112. In one further example embodiment, first means 111 are designed in such a way that they forward the received surroundings data values—without data processing elements—to third means 112.

Furthermore, first device includes second means 112 which are designed to determine an instantaneous driving situation in which automated vehicle 200 is situated, as a function of surroundings 220 of automated vehicle 200. For this purpose, second means 112 are designed as a processing unit, for example, which includes electronic data processing elements, for example a processor, a working memory and a hard drive. Moreover, second means 112 encompass corresponding software which is designed to determine the instantaneous driving situation, as a function of surroundings 220 of automated vehicle 200.

The instantaneous driving situation is determined, for example, in that the surroundings data values, which are present as at least one (digital) image, for example, are evaluated. This takes place, for example, in that surroundings 220 are assigned to a surroundings class, the evaluation taking place with the aid of an object classification and, for example, a traffic sign and/or a certain surroundings feature being identified as a classified object, which allows an assignment to the surroundings class. In one further example embodiment, the driving situation is determined, for example, in that different surroundings and/or motion scenarios in the form of data values are stored in second means 112, and the assignment to surroundings and/or motion classes takes place with the aid of a comparison of the surroundings data values to the stored surroundings and/or motion scenarios.

In one method example, for example, a traffic sign is identified, which is unambiguously assigned to a freeway, whereby surroundings 220 of automated vehicle 200 are assigned to the “freeway” surroundings class. In addition or as an alternative, it is identified, for example with the aid of a comparison proceeding from at least two images, that automated vehicle 200 is moving since surroundings 220 of automated vehicle 200 are changing. The driving situation is thus determined as “driving on a freeway.”

In one further method example, a tunnel wall is identified as a surroundings feature, for example, whereby surroundings 220 of automated vehicle 200 are assigned to the “tunnel” surroundings class. In addition or as an alternative, it is identified, for example with the aid of a comparison proceeding from at least two images, that automated vehicle 200 is moving slowly since surroundings 220 of automated vehicle 200 are changing. The driving situation is thus determined as “slow driving in a tunnel.”

In one further method example, a traffic intersection is identified as a surroundings feature, for example, whereby surroundings 220 of automated vehicle 200 are assigned to the “intersection” surroundings class. In addition or as an alternative, it is identified, for example with the aid of a comparison proceeding from at least two images, that automated vehicle 200 is not moving since surroundings 220 of automated vehicle 200 are not changing. The driving situation is thus determined as “standing at an intersection.”

Furthermore, first device 110 encompasses third means 113 for operating 330 automated vehicle 200, as a function of the instantaneous driving situation. For this purpose, third means 113 encompass a transceiver unit, with the aid of which data are requested and/or received. In one further example embodiment, third means 113 are designed in such a way that these means are connected to an externally situated transceiver unit 122—proceeding from first device 110 with the aid of a cable link and/or wireless link 121. In one further example embodiment, the transceiver units are identical to the transceiver units of first means 111.

The driving situation is transmitted in the form of data values, for example, in such a way that operation 330 of automated vehicle 200 takes place in that the instantaneous driving situation is transmitted to automated vehicle 200 and/or a signal for controlling automated vehicle 200, as a function of the instantaneous driving situation, is transmitted to automated vehicle 200.

Controlling automated vehicle 200 is understood to mean, for example, that, proceeding from the signal for controlling, which is transmitted, for example, to at least one control unit of automated vehicle 200, a transverse and/or longitudinal control of automated vehicle 200 takes place.

In one further example embodiment, for example, automated vehicle 200 is operated in such a way that the driving situation is output visually and/or acoustically and/or haptically to one or multiple occupants of automated vehicle 200, for example a driver (if automated vehicle 200 is designed as a semi-automated vehicle) with the aid of an output unit. For example, the output includes the prompt to carry out the control of the semi-automated vehicle manually (by the driver).

In one further example embodiment, third means 113 include, for example, electronic data processing elements, for example a processor, a working memory or a hard drive. For example, different driving situations (in the form of data values) are stored on the hard drive, and operation 330 of automated vehicle 200 takes place in that, as a function of a comparison of the particular driving situation to a stored driving situation, a signal for controlling automated vehicle 200 is transmitted to automated vehicle 200.

For example, operation 330 of automated vehicle 200 takes place in that, as a function of the driving situation “driving on the freeway,” a freeway pilot of automated vehicle 200 is started.

In one further example embodiment, operation 330 of automated vehicle 200 takes place in that, for example, “standing at a parking space” is determined as the driving situation and the signal for controlling automated vehicle 200 executes a parking pilot of automated vehicle 200.

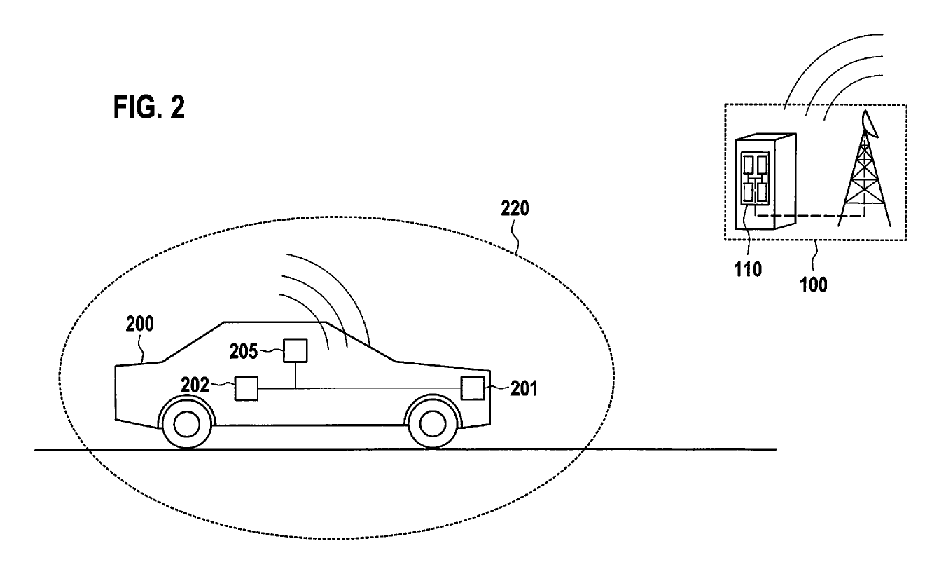

FIG. 2 shows one exemplary embodiment of method 300 according to the present invention for operating 330 an automated vehicle 200. Surroundings data values, which represent surroundings 220 of automated vehicle 200, are received by device 110 with the aid of first means 111, and an instantaneous driving situation in which automated vehicle 200 is situated is determined with the aid of second means 112, as a function of surroundings 220 of automated vehicle 200. Subsequently, automated vehicle 200 is operated with the aid of third means 113, as a function of the instantaneous driving situation.

Automated vehicle 200 includes, for example, a surroundings sensor system 201, with the aid of which the surroundings data values are detected, and/or a data compression unit 202, with the aid of which the surroundings data values are compressed, and/or a transceiver unit 205, with the aid of which the surroundings data values are transmitted to first means 111 or to device 110.

In an example embodiment, the transceiver unit is additionally or alternatively designed to receive a signal for controlling automated vehicle 200, proceeding from device 110, in particular as a function of the instantaneous driving situation which is determined with the aid of second means 112.

In a further example embodiment, automated vehicle 200 includes, for example, an output unit (not shown in the figure), which is designed to output the signal visually and/or acoustically and/or haptically.

In a further example embodiment, automated vehicle 200 includes, for example, at least one control unit (not shown in the figure), which is designed to operate automated vehicle 200, as a function of the instantaneous driving situation, for example in that a transverse and/or longitudinal control of automated vehicle 200 takes place with the aid of the at least one control unit.

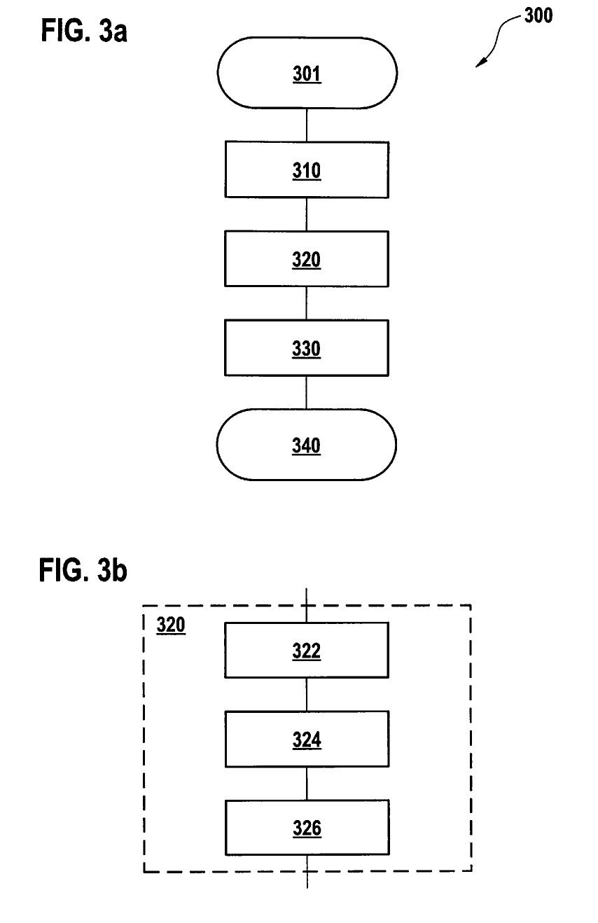

FIG. 3a shows one exemplary embodiment of a method 300 for operating 330 an automated vehicle 200. In step 301, method 300 starts. In step 310, surroundings data values which represent surroundings 220 of automated vehicle 200 are received. In step 320, an instantaneous driving situation in which automated vehicle 200 is situated is determined, as a function of surroundings 220 of automated vehicle 200. In step 330, automated vehicle 200 is operated, as a function of the instantaneous driving situation. In step 340, method 300 ends.

FIG. 3b shows one exemplary embodiment of the determination 320 of an instantaneous driving situation in which automated vehicle 200 is situated. In step 322, the localization of automated vehicle 200 takes place in that surroundings 220 of automated vehicle 200 are assigned to a surroundings class. In step 324, the determination of the operating state of automated vehicle 200 takes place in that the operating state is assigned to a motion class. In step 326, an instantaneous driving situation is determined, as a function of the localization in step 322 and/or as a function of the determination of the operating state in step 324, for example in that the instantaneous driving situation corresponds to a combination of the surroundings class and of the motion class. Step 322 and step 324 can also be carried out in the reverse order.

What is claimed is:

1. A method for operating an automated vehicle, the method comprising:
obtaining, by a processor, surroundings data values that represent surroundings of the automated vehicle;
determining, by the processor, an instantaneous driving situation of the automated vehicle as a function of the obtained surroundings data values; and
the processor operating the automated vehicle as a function of the instantaneous driving situation.

2. The method of claim 1, wherein the determined instantaneous driving situation includes at least one a localization of the automated vehicle, a determination of an operating state of the automated vehicle, and a determination of a traffic situation in the surroundings of the automated vehicle.

3. The method of claim 1, wherein the processor is external to the automated vehicle.

4. The method of claim 1, wherein the operating includes transmitting to the automated vehicle at least one of the instantaneous driving situation and a signal for controlling the automated vehicle and that is a function of the instantaneous driving situation.

5. The method of claim 1, wherein the surroundings data values are at least one of detected using at least one sensor of the automated vehicle, compressed using a data compression unit of the automated vehicle, and transmitted using a transceiver unit of the automated vehicle.

6. The method of claim 1, wherein the determined instantaneous driving situation includes a localization of the automated vehicle, which includes assigning the surroundings of the automated vehicle to a surroundings class.

7. The method of claim 1, wherein the determined instantaneous driving situation includes a determination of an operating state of the automated vehicle, the determined operating state being assigned to a motion class.

8. The method of claim 1, wherein:
the determination of the instantaneous driving situation includes:
localizing the automated vehicle by assigning the surroundings of the automated vehicle to a surroundings class; and
determining, and assigning to a motion class, an operating state of the automated vehicle; and
the determined instantaneous driving situation corresponds to a combination of the surroundings class and the motion class.

9. A device for operating an automated vehicle, the device comprising:
a processor, wherein the processor is configured to:
obtain surroundings data values that represent surroundings of the automated vehicle;
determine an instantaneous driving situation of the automated vehicle as a function of the obtained surroundings data values; and
operate the automated vehicle as a function of the instantaneous driving situation.

10. The device of claim 9, wherein the determined instantaneous driving situation includes at least one a localization of the automated vehicle, a determination of an operating state of the automated vehicle, and a determination of a traffic situation in the surroundings of the automated vehicle.

11. The device of claim 9, wherein the processor is external to the automated vehicle.

12. The device of claim 9, wherein the operation includes transmitting to the automated vehicle at least one of the instantaneous driving situation and a signal for controlling the automated vehicle and that is a function of the instantaneous driving situation.

13. The device of claim 9, wherein the surroundings data values are at least one of detected using at least one sensor of the automated vehicle, compressed using a data compression unit of the automated vehicle, and transmitted using a transceiver unit of the automated vehicle.

14. The device of claim 9, wherein the determined instantaneous driving situation includes a localization of the automated vehicle, which includes assigning the surroundings of the automated vehicle to a surroundings class.

15. The device of claim 9, wherein the determined instantaneous driving situation includes a determination of an operating state of the automated vehicle, the determined operating state being assigned to a motion class.

16. The device of claim 9, wherein:
the determination of the instantaneous driving situation includes:
localizing the automated vehicle by assigning the surroundings of the automated vehicle to a surroundings class; and
determining, and assigning to a motion class, an operating state of the automated vehicle; and
the determined instantaneous driving situation corresponds to a combination of the surroundings class and the motion class.
